(19) United States
(12) Patent Application Publication
(10) Pub. No.: US 2003/0021560 A1
(43) Pub. Date: Jan. 30, 2003

(54) Optical fiber ribbon and optical fiber cable

(75) Inventors: Keiji Ohashi, Chiba (JP); Katsuyoshi Ishida, Gunma (JP); Etsuo Ino, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: FUJIKURA LTD., Tokyo (JP)

(21) Appl. No.: 10/189,390

(22) Filed: Jul. 8, 2002

(30) Foreign Application Priority Data
Jul. 10, 2001 (JP) 2001-209675

(51) Int. Cl. G02B 6/44

(52) U.S. Cl. 385/114

(57) ABSTRACT

An optical fiber ribbon and an optical fiber cable are described in which light loss during winding an optical fiber ribbon on a bobbin and during installation of optical fiber ribbons in an optical fiber cable is prevented by giving slip characteristics to the surface of the optical fiber ribbon to avoid increase of light loss. The optical fiber ribbon comprises a plurality of individual optical fibers and a ribbon material covering said individual optical fibers in the form of a ribbon. The ribbon material is made of a UV curable resin having a monomer structure or an oligomer structure and provided with a slip characteristic. The optical fiber cable is composed of a plurality of the optical fiber ribbons.

### CROSS REFERENCE TO RELATED APPLICATIONS

This application is based upon and claims the benefit of priority from prior Japanese Patent Application P2001-209675 filed on Jul. 10, 2001; the entire contents of which are incorporated by reference herein.

### BACKGROUN OF THE INVENTION

1. Field of the Invention

The present invention relates to an optical fiber ribbon and an optical fiber cable. More particularly, the present invention relates to a technique for preventing loss increase during winding an optical fiber ribbon on a bobbin and during installation of optical fiber ribbons in an optical fiber cable by giving slip characteristics to the surface of an optical fiber ribbon and therefore to avoid increase of light loss.

2. Description of the Related Art

In the related art technique, an optical fiber ribbon is fabricated by a plurality of individual optical fibers, which are arranged in parallel, covered with a jacket layer made of a resin tape material (resin ribbon material) on the individual optical fibers and united together in the form of a tape (ribbon).

The optical fiber ribbon as formed in this manner is wound on a bobbin having a diameter of about 300 mm for storage. However, depending on the characteristics of the material of the jacket layer or the condition when the optical fiber ribbon is manufactured, the surface of the jacket layer sometimes becomes frictional and therefore the winding condition may be disturbed when the optical fiber ribbon is wound on a bobbin, while the optical fiber ribbon is sometimes inverted or bended, increasing loss of ray energy passing through the optical fiber ribbon.

In order to prevent the winding disturbance on the bobbin, a lubricant such as talc powder or an oil type material is applied to the surface of the optical fiber ribbon.

Also, this type of the optical fiber ribbons is used to manufacture an optical fiber cable by bundling them.

On the other hand, there are following shortcomings in the case of the related art optical fiber ribbon.

(1) When the lubricant such as talc powder is not uniformly applied, the loss may increase during winding the optical fiber ribbon on a bobbin.

(2) When a liquid lubricant such as an oil is used as the lubricant applied to the ribbon, the optical fiber ribbon (the jacket layer) may swell and become sticky.

Also, since an optical fiber cable is formed by bundling a plurality of optical fiber ribbons, it is also susceptible to the same problem. In addition to this, in the case of a ribbon and slot type cable which is particularly susceptible to a side pressure, for example, there is a shortcoming that relative movement of optical fiber ribbons within a slot is restricted due to talc powder in the slot and therefore the strain is increased.

### BRIEF SUMMARY OF THE INVENTION

It is an object of the present invention to solve the above described problems and to provide an optical fiber ribbon and an optical fiber cable in which it is possible to avoid increase of light loss during winding the optical fiber ribbon on a bobbin and during installation of the optical fiber ribbon in the optical fiber cable due to poor slip characteristics of the surface of the optical fiber ribbon.

In order to accomplish the above described object, the optical fiber ribbon in accordance with the present invention comprises a plurality of individual optical fibers and a ribbon material covering said individual optical fibers in the form of a ribbon. The ribbon material is made of a UV curable resin having a monomer structure or an oligomer structure and provided with a slip characteristic.

Accordingly, since the ribbon material has slip characteristics itself, it is possible to dispense with application of a lubricant, to maintain low the loss as caused during winding an optical fiber ribbon on a bobbin due to nonuniform application of a lubricant, and to prevent the surface of the ribbon from being sticky and viscous and from swelling. As a result, it becomes possible to prevent the light loss from increasing.

In accordance with a preferred embodiment of the present invention, the UV curable resin of the optical fiber ribbon is a UV curable urethane acrylate resin.

Accordingly, since a UV curable urethane acrylate can be easily converted to a monomer structure or an oligomer structure to improve the slip characteristics thereof, the productivity thereof is substantially improved.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a cross sectional view showing the optical fiber ribbon (8-fiber ribbon) in accordance with an embodiment of the present invention.

FIG. 2 is a schematic diagram showing a manufacturing apparatus 11 for manufacturing the optical fiber ribbon 1 from a plurality of the individual optical fibers 3 which are wound up on a supply bobbin.

### DETAILED DESCRIPTION OF THE INVENTION

In the followings, an embodiment of the present invention will be described with reference to the accompanying drawings.

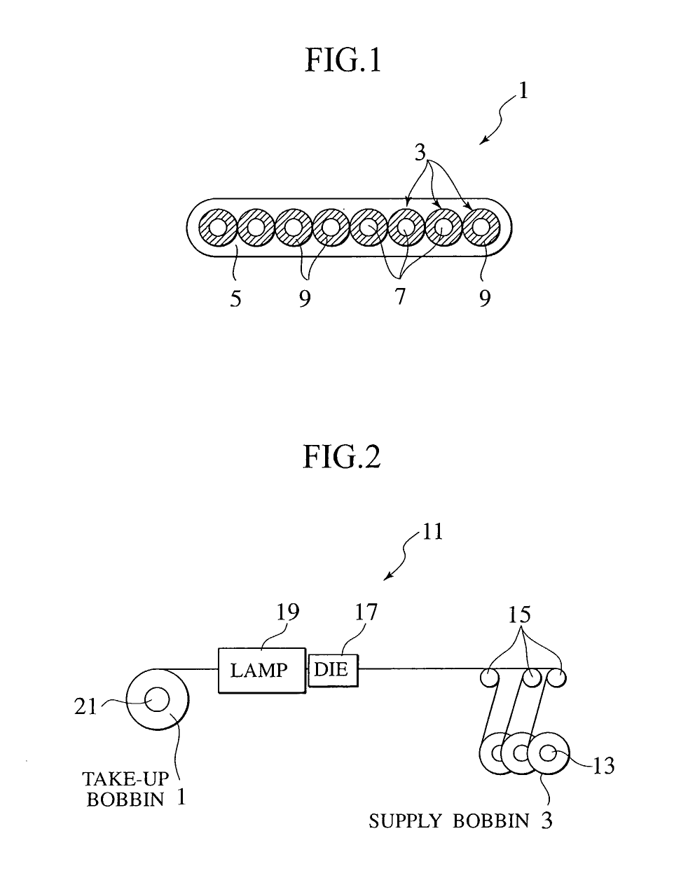

As illustrated in FIG. 1, the optical fiber ribbon 1 in accordance with the present invention is composed of a plurality of individual optical fibers 3, which are arranged in parallel, covered with a block jacket layer 5 (called also a secondary jacket layer) made of a resin ribbon material on the individual optical fibers and united together in the form of a tape. The number of the individual optical fibers 3 is selected to be an arbitrary number more than one.

The type of the individual optical fibers 3 can also be arbitrarily selected. For example, each individual optical fiber 3 may be formed of a bare optical fiber 7 having an external diameter of 125 micrometers which is covered with a UV curable resin coating 9 (UV resin) as a primary jacket layer, whose external diameter is 250 to 400 micrometers for example.

The block jacket layer 5 is formed in order that the cross sectional profile of the optical fiber ribbon 1 is flat and therefore the optical fiber ribbon 1 appears tape-like. If the thickness of the block jacket layer 5 is too small, the mechanical strength of the optical fiber ribbon 1 becomes low. On the other hand, if the thickness of the block jacket layer 5 is too large, there is a disadvantage in highly density packing optical fiber ribbons in the cable. Accordingly, the thickness of the block jacket layer 5 is determined depending on the application of the optical fiber ribbon 1 and the type of the resin comprising the block jacket layer 5.

For example, the optical fiber ribbon 1 as illustrated in FIG. 1 is composed of eight individual optical fibers 3 having an external diameter of 250 micrometers and covered with a UV resin coating as the block jacket layer 5 to form an 8-fiber ribbon.

Also, optical fiber cables are structurally classified on the basis of the way of protecting and collecting optical fiber bundles (such as optical fiber ribbons and the like) and the location of the tension member. For example, there are a piped type in which optical fiber bundles are loosely collected in a pipe as a cable sheath, a strand type in which optical fiber bundles are tightly twisted and a slot type in which optical fiber bundles are inserted into slots.

For example, a slot type optical fiber cable is composed of a plurality of the optical fiber ribbons 1 stacked in the form of unit blocks which are arranged on a tension member as a center. The respective unit blocks are formed with a slot rod in between.

FIG. 2 is a schematic diagram showing a manufacturing apparatus 11 for manufacturing the optical fiber ribbon 1 from a plurality of the individual optical fibers 3 which are wound up on a supply bobbin. There are eight supply bobbins 13 provided in the manufacturing apparatus 11 for winding a sufficient length of each individual optical fiber 3 respectively, while only three bobbins are illustrated in FIG. 2. With each supply bobbin 13 rotating, each of the individual optical fibers 3 wound thereon is passed through a guide roller 15 and transported to a die 17. The individual optical fibers 3 are covered with a secondary jacket layer as the block jacket layer 5 made of a UV curable resin and the like in the die 17, then passed through a lamp 19 and finally wound on a take-up bobbin 21.

The block jacket layer 5, which is related to a primary feature of the present invention, is formed of a UV curable resin having a monomer structure or an oligomer structure and provided with excellent slip characteristics. The UV curable resin is created, for example, by modifying a UV curable urethane acrylate to have a monomer structure or an oligomer structure to improve the slip characteristics thereof.

Meanwhile, when the optical fiber ribbon 1 is wound up by means of the take-up bobbin 21, no lubricant such as a powdered lubricant or a liquid lubricant is applied thereto, unlike the prior art technique. Since the block jacket layer 5 made of a UV curable urethane acrylate has slip characteristics itself as the tape member, it is possible to maintain low the loss during winding an optical fiber ribbon on a bobbin even without application of a lubricant, and to prevent the surface of the ribbon from being sticky and viscous and from swelling.

In the case of an optical fiber cable in which the optical fiber ribbons 1 are bundled, the assembling process of the optical fiber cable can be performed without application of a lubricant. Even in the case of a ribbon and slot type cable which is particularly susceptible to a side pressure, for example, the optical fiber ribbons can be moved relative to each other within the slot to decrease the strain of the fibers.

Meanwhile, as experiments, Embodiment 1 was prepared of the optical fiber ribbon 1 as an 8-fiber ribbon with the block jacket layer 5 made of a UV curable urethane acrylate of a monomer structure or an oligomer structure having slip characteristics. Also, Comparative Conventional Art 1 was prepared of an optical fiber ribbon as an 8-fiber ribbon with a block jacket layer to which talc is applied as a power lubricant. Furthermore, Comparative Conventional Art 2 was prepared of the optical fiber ribbon 1 as an 8-fiber ribbon with a block jacket layer to which a paraffin oil is applied as a liquid lubricant. Then, after winding them on the take-up bobbin 21, defective points caused by winding disturbance were detected for each optical fiber ribbon by means of an OTDR (Optical Time Domain Reflectometer). The results are as shown in the following Table 1. Namely, there was found no defective point in the case of Embodiment 1 while defective points appeared in the case of Comparative Conventional Arts 1 and 2.

TABLE 1

| | Application | | Fiber Strain | |
|---|---|---|---|---|
| | of Lubricant | Bobbin OTDR | within Cable | Remarks |
| Embodiment | No | No defective | 0.01% | |
| 1 | | point | | |
| Comparative | Talc | Defective points | 0.04% | Adhesive |
| Prior Art 1 | | appearing | | become |
| | | | | ineffective |
| Comparative | Paraffin oil | Defective points | 0.05% | Gooey |
| Prior Art 2 | | appearing | | |

Furthermore, for each of Embodiment 1, Comparative Conventional Art 1 and Comparative Conventional Art 2 as described above, a single-mode 1000-fiber WBA cable of 700 m length was manufactured with the optical fiber ribbons respectively by way of trial. Afterward, the largest strain of the optical fiber ribbons installed in the slots of each cable was measured by means of a B-OTDR (Brillouin Optical Time Domain Reflectometer). As a result, the above strain of the embodiment is maintained low as compared with those of Comparative Conventional Art 1 and Comparative Conventional Art.

As understood from the above described embodiment, since the UV curable resin as the ribbon material itself possesses slip characteristics, it is possible to dispense with a lubricant, which would otherwise be required to be applied to the surface of the ribbon after hardening, and therefore to improve the productivity thereof. Furthermore, it is no longer that case where the loss is increased during winding an optical fiber ribbon on a bobbin when the lubricant is not uniformly applied and is also no longer the case that the surface of the ribbon becomes sticky and viscous and swelling, and therefore the loss of ray energy is effectively prevented.

Also a UV curable urethane acrylate can be easily converted to a monomer structure or an oligomer structure to improve the slip characteristics thereof, and therefore the productivity thereof is substantially improved.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

What is claimed is:

1. An optical fiber ribbon comprising:
a plurality of individual optical fibers;
a ribbon material covering said individual optical fibers in the form of a ribbon,
wherein said ribbon material is made of a UV curable resin having a monomer structure or an oligomer structure and provided with a slip characteristic.

2. The optical fiber ribbon as claimed in claim 1 wherein said UV curable resin is a UV curable urethane acrylate resin.

3. An optical fiber cable comprising:
a plurality of optical fiber ribbons;
a cable sheath for accommodating said optical fiber ribbons,
wherein the surfaces of said optical fiber ribbons are made of a UV curable resin having a monomer structure or an oligomer structure and provided with a slip characteristic.

4. The optical fiber cable as claimed in claim 3 wherein said UV curable resin is a UV curable urethane acrylate resin.
